(19) United States
(12) Patent Application Publication
(10) Pub. No.: US 2025/0011483 A1
(43) Pub. Date: Jan. 9, 2025

(54) REINFORCED POLYPROPYLENE COMPOSITION

(71) Applicants: Basell Polyolefine GMBH, Wesseling (DE); Albert-Ludwigs-Universität Freiburg, Freiburg (DE)

(72) Inventors: Carl Gunther Schirmeister, Denzlingen (DE); Erik Hans Licht, Mainz (DE); Timo Hees, Mainz (DE); Jürgen Rohrmann, Kelkheim (DE); Rainer Köhler, Pegnitz (DE); Shahram Mihan, Bad Soden (DE); Yannic Kessler, Kriftel (DE); Rolf Muelhaupt, Freiburg (DE)

(73) Assignees: Basell Polyolefine GMBH, Wesseling (DE); Albert-Ludwigs-Universität Freiburg, Freiburg (DE)

(21) Appl. No.: 18/702,151

(22) PCT Filed: Oct. 10, 2022
(86) PCT No.: PCT/EP2022/078112

§ 371 Date: Apr. 17, 2024

(30) Foreign Application Priority Data
Oct. 28, 2021 (EP) 21205228.6

(51) Int. Cl. C08F 210/16; B33Y 80/00; C08J 5/04

(52) U.S. Cl. CPC C08F 210/16; B33Y 80/00; C08J 5/043; C08J 2323/08; C08J 2323/14

(57) ABSTRACT

A polyolefin composition (I) made from or containing:
(A) 15-80% by weight of a heterophasic polymer composition made from or containing:
   (a) 50-80% by weight of a propylene polymer, and
   (b) 20-50% by weight of a copolymer of ethylene and an alpha-olefin; and
(B) 20-85% by weight of a polyethylene composition made from or containing:
   (i) 25-85% by weight of a polyethylene component, having a weight average molecular weight Mw(i), equal to or higher than 1,000,000 g/mol; and
   (ii) 10-65% by weight of a polyethylene component, having an Mw(ii) equal to or lower than 5,000 g/mol,
   wherein the polyethylene composition (B) is made from or containing at least 70% by weight of (i)+(ii).

### FIELD OF THE INVENTION

In general, the present disclosure relates to the field of chemistry. More specifically, the present disclosure relates to polymer chemistry. In particular, the present disclosure relates to a polyolefin composition and to injection molded or 3D-printed articles obtained therefrom.

### BACKGROUND OF THE INVENTION

In some instances and to compete with other engineered materials, polyolefins are reinforced with inorganic fillers. In some instances, the inorganic fillers are glass fibers or minerals.

In some instances, the filled polyolefins are used in the automotive field for the injection molding of interior and exterior parts.

In some instances, the presence of inorganic fillers has a negative impact on the environmental sustainability of filled materials.

In some instances, the mechanical properties of mechanically recycled glass-fibers-filled polyolefins deteriorate over time. It is believed that the fibers are broken and shredded with each recycling step. Thus, the life cycle of inorganically filled plastic materials is shorter than that of unfilled materials, and the inorganically filled plastic materials rapidly turn into disposable wastes.

In some instances and when chemical recycled, the inorganic fillers are separated from the polyolefin matrix, thereby increasing the complexity of the recycling process and reducing sustainability.

In some instances, plastic, filled with inorganic fillers, has a density higher than the corresponding unfilled material. In some instances, the higher density increases the weight carried by the transporting vehicles, yielding a higher fuel consumption for combustion engine transportation vehicles or a reduced range of electrical transportation vehicles.

### SUMMARY OF THE INVENTION

In a general embodiment, the present disclosure provides a polyolefin composition (I) made from or containing:

(A) 15-80% by weight of a heterophasic polymer composition made from or containing:
(a) 50-80% by weight of a propylene polymer selected from the group consisting of propylene homopolymers, propylene copolymers, and mixtures thereof,
wherein the propylene copolymers are propylene copolymers with ethylene or an alpha-olefin of formula CH₂═CHR¹, wherein R¹ is a linear or branched C2-C8 alkyl, and have up to and including 10.0% by weight, alternatively from 0.05 to 8.0% by weight, of units deriving from ethylene or the alpha-olefin, based on the weight of (a); and
(b) 20-50% by weight of a copolymer of ethylene and an alpha-olefin of formula CH₂═CHR¹, wherein R¹ is a linear or branched C2-C8 alkyl, having from 10 to 40% by weight, alternatively from 20 to 35% by weight, of units deriving from the alpha-olefin, based on the weight of (b), wherein the amounts of components (a) and (b) are based on the total weight of (a)+(b); and

(B) 20-85% by weight of a polyethylene composition made from or containing
(i) 25-85% by weight of a polyethylene component, having a weight average molecular weight Mw(i), measured by Gel Permeation Chromatography, equal to or higher than 1,000,000 g/mol; and
(ii) 10-65% by weight of a polyethylene component, having a weight average molecular weight Mw(ii), measured by Gel Permeation Chromatography, equal to or lower than 5,000 g/mol,
wherein the polyethylene composition (B) is made from or containing at least 70% by weight of (i)+(ii) and the amounts of (i) and (ii) are based on the total weight of the polyethylene composition (B), the total weight being 100%,
and wherein the amounts of components (A) and (B) are based on the total weight of (A)+(B).

In some embodiments, the present disclosure provides a process for manufacturing a shaped article including the step of subjecting a flow of the molten polyolefin composition (I) to a shear rate equal to or greater than 50 s⁻¹.

In some embodiments, the present disclosure provides a process for reinforcing a heterophasic polymer composition (A) including the step of admixing, as reinforcing masterbatch, a polyethylene composition (B) made from or containing:
(i) 25-85% by weight of a polyethylene component, having a weight average molecular weight Mw(i), measured by Gel Permeation Chromatography, equal to or higher than 1,000,000 g/mol; and
(ii) 10-65% by weight of a polyethylene component, having a weight average molecular weight Mw(ii), measured by Gel Permeation Chromatography, equal to or lower than 5,000 g/mol,
wherein the polyethylene composition (B) is made from or containing at least 70% by weight of (i)+(ii) and the amounts of (i) and (ii) are based on the total weight of the polyethylene composition (B), the total weight being 100%,
to a heterophasic polymer composition (A) made from or containing:
(a) 50-80% by weight of a propylene polymer selected from the group consisting of propylene homopolymers, propylene copolymers, and mixtures thereof,
wherein the propylene copolymers are propylene copolymers with ethylene or an alpha-olefin of formula CH₂═CHR¹, wherein R¹ is a linear or branched C2-C8 alkyl, and have up to and including 10% by weight, alternatively from 0.05 to 8% by weight, of units deriving from ethylene and/or the alpha-olefin, based on the weight of (a); and
(b) 20-50% by weight of a copolymer of ethylene and an alpha-olefin of formula CH₂═CHR¹, wherein R¹ is a linear or branched C2-C8 alkyl, having from 10 to 40% by weight, alternatively from 20 to 35% by weight, of units deriving from the alpha-olefin, based on the weight of (b),
wherein the amounts of components (a) and (b) are based on the total weight of (a)+(b).

In some embodiments, the polyolefin composition (I) has a reduced density in comparison to the heterophasic polyolefin composition (A) reinforced with inorganic fillers. In some embodiments, the inorganic fillers are glass fibers.

In some embodiments, the polyolefin composition (I) is converted into shaped articles using extruders. In some embodiments, the extruders are twin-screw extruders.

While multiple embodiments are disclosed, still other embodiments will become apparent to those skilled in the art from the following detailed description. As will be apparent, certain embodiments, as disclosed herein, are capable of modifications in various aspects, without departing from the spirit and scope of the claims as presented herein. Accordingly, the following detailed description is to be regarded as illustrative in nature and not restrictive.

### DETAILED DESCRIPTION OF THE INVENTION

In the present disclosure, the percentages are expressed by weight, unless otherwise specified. The total weight of a composition sums up to 100%, unless otherwise specified.

In the present disclosure, when referred to polymers, the term “blend” refers to (a) reactor-made blends, that is, blends of at least two polymeric components obtained directly from a polymerization process, (b) mechanical blends, that is, blends obtained by melt-mixing at least two distinct polymeric components, and (c) combinations of reactor-made blends and mechanical blends.

In the present disclosure, when the term “comprising” refers to a polymer, a polymer composition, a mixture, or a blend, the term should be construed to mean “comprising or consisting essentially of”.

In the present disclosure, the term “consisting essentially of” means that, in addition to the specified components, the polymer, the polymer composition, the mixture, or the blend may be further made from or containing other components, provided that the characteristics of the polymer or of the polymer composition, the mixture, or the blend are not materially affected by the presence of the other components. In some embodiments, the other components are catalyst residues, antistatic agents, melt stabilizers, light stabilizers, antioxidants, and antacids.

In some embodiments, the polyolefin composition (I) is made from or containing 15-80% by weight, alternatively 40-80% by weight, alternatively 50-70% by weight, of the heterophasic polymer composition (A), and 20-85% by weight, alternatively 20-60% by weight, alternatively 30-50% by weight, of the polyethylene composition (B).

In some embodiments, the polyolefin composition (I) has at least one of the, alternatively has the, following properties:
a melt flow rate MFR(tot), measured according to the method ISO 1133-2:2011 at 230° C. with a load of 2.16 Kg, of 0.001-5.0 g/10 min; or
a density, measured according to ASTM standard D792-08, equal to or lower than 1.00 g/cm³; or
a tensile modulus, measured according to the method ISO 527-1:2012 on injection molded specimens, at least 100% higher than the tensile modulus of the heterophasic polymer composition (A), alternatively at least 150% higher, alternatively at least 200% higher.
   In some embodiments, the lower limit for the density is equal to or greater than 0.90 g/cm³. In some embodiments, the upper limit for the tensile module of the polyolefin composition (I) is less 500% higher than the tensile modulus of the heterophasic polymer composition (A).

In some embodiments, the polyolefin composition (I) is free of an inorganic reinforcing agent or a fiber-reinforcing agent. In some embodiments, the absent inorganic reinforcing agent is selected from the group consisting of glass fibers or mineral fillers. In some embodiments, the absent fiber-reinforcing agent is selected from the group consisting of polyolefin fibers and wool.

In some embodiments, the polyolefin composition (I) is made from or containing component (B) as reinforcing agent, in the absence of any other reinforcing agent.

In some embodiments, the polyolefin composition (I) is made from or containing the following components in any combination.

In some embodiments, the heterophasic polymer composition (A) is made from or containing components (a) and (b), wherein components (a) and (b) are copolymers having the alpha-olefin independently selected from the group consisting of butene-1, hexene-1,4-methyl-1-pentene, octene-1, and combinations thereof. In some embodiments, the alpha-olefin is butene-1.

In some embodiments, component (a) is a blend of propylene polymers.

In some embodiments, component (a) is a propylene homopolymer or a blend of propylene homopolymers.

In some embodiments, component (a) has at least one of the, alternatively has the, following properties:
a fraction soluble in xylene at temperature of 25° C. XS (a) equal to or lower than 5% by weight, alternatively equal to or lower that 3% by weight, based on the weight of (a); or
a melt flow rate MFR(a), measured according to the method ISO 1133-2:2011 at a temperature of 230° C., with a load of 2.16 Kg, equal to or higher than 50 g/10 min., alternatively ranging from 50 to 300 g/10 min.
   In some embodiments, the lower limit the xylene fraction soluble is 0.1 wt. %, based on the weight of (a), for each upper limit.

In some embodiments, component (a) is a propylene homopolymer or a blend of propylene homopolymers having the properties above.

In some embodiments, component (b) is an ethylene copolymer or a blend of ethylene copolymers.

In some embodiments, component (b) is a copolymer or a blend of copolymers of ethylene and 1-butene.

In some embodiments, component (b) has at least one of the, alternatively has the, following properties:
a weight average molecular weight Mw, measured by GPC, equal to or greater than 50,000 g/mol, alternatively ranging from 50,000 to less than 1,000,000 g/mol; or
a fraction soluble in xylene at temperature of 25° C. XS (b) equal to or greater than 40 wt. %, alternatively equal to or greater than 65 wt. %, based on the weight of (b). In some embodiments, the upper limit of the fraction soluble in xylene at temperature of 25° C. XS (b) is equal to 100 wt. %, for each lower limit.

In some embodiments, the heterophasic polymer composition (A) is made from or containing:
(a) 35-70% by weight, alternatively 40-65% by weight, of a propylene polymer selected from the group consisting of propylene homopolymers and propylene copolymers with ethylene or an alpha-olefin of formula CH₂═CHR¹, wherein R¹ is a linear or branched C2-C8 alkyl, having up to and including 10.0% by weight, alternatively from 0.05 to 8.0% by weight, of units deriving from ethylene or the alpha-olefin, based on the weight of (a);
(b) 15-40% by weight, alternatively 20-35% by weight, of a copolymer of ethylene and an alpha-olefin of formula CH₂═CHR¹, wherein R¹ is a linear or branched C2-C8 alkyl, having from 10 to 40% by weight, alternatively from 20 to 35% by weight, of units deriving from the alpha-olefin, based on the weight of (b); and
(c) 5-30% by weight, alternatively 7-20% by weight, of a copolymer of propylene with ethylene or an alpha-olefin of formula CH₂═CHR¹, wherein R¹ is a linear or branched C2-C8 alkyl, having up to and including 50% by weight, alternatively from 15 to 50% by weight, of units deriving from ethylene or the alpha-olefin, based on the weight of (c);
wherein the amounts of components (a), (b), and (c) are based on the total weight of (a)+(b)+(c).

In some embodiments, the propylene copolymer (c) is selected from propylene-ethylene copolymers.

In some embodiments, the heterophasic polymer composition (A) is further made from or containing up to and including 3.0% by weight, alternatively from 0.01 to 3.0% by weight, of an additive (d) selected from the group consisting of antistatic agents, anti-oxidants, light stabilizers, slipping agents, anti-acids, melt stabilizers, and combinations thereof, wherein the amount of the additive (d) is based on the total weight of the polyolefin composition further made from or containing the additive (d), the total weight being 100%.

In some embodiments, the heterophasic polymer composition (A) has a melt flow rate MFR(A), measured according to the method ISO 1133-2:2011 at a temperature of 230° C., with a load of 2.16 Kg, equal to or greater than 8.0 g/10 min. In some embodiments, the MFR(A), measured according to the method ISO 1133-2:2011 at a temperature of 230° C., with a load of 2.16 Kg, is equal to or lower than 150 g/10 min.

In some embodiments, the heterophasic polymer composition (A) is a reactor-blend, a melt-blend, or a combination thereof.

In some embodiments, the heterophasic polymer composition (A) is a reactor blend heterophasic polyolefin composition (A1) made from or containing:
(a) 35-70% by weight, alternatively 40-65% by weight, of a propylene homopolymer;
(b) 15-40% by weight, alternatively 20-35% by weight, of a copolymer of ethylene and 1-butene, having from 10 to 40% by weight, alternatively from 20 to 35% by weight, of units deriving from 1-butene, based on the weight of (b);
(c) 5-30% by weight, alternatively 7-25% by weight, of a copolymer of propylene with ethylene, having up to and including 50% by weight, alternatively from 15 to 50% by weight, of units deriving from ethylene, based on the weight of (c); and
(d) optionally up to and including 3.0% by weight, alternatively from 0.01% to 3.0% by weight, of an additive selected from the group consisting of antistatic agents, anti-oxidants, light stabilizers, slipping agents, anti-acids, melt stabilizers, and combinations thereof,
wherein the amounts of components (a), (b), (c), and (d) are based on the total weight of (a)+(b)+(c)+(d), the total weight being 100%.

In some embodiments, the heterophasic polyolefin composition (A1) has at least one of the, alternatively has the, following properties:
a fraction soluble in xylene at temperature of 25° C. XS (A1) ranging from 30% to 50% by weight, based on the weight of (A1); or
an intrinsic viscosity of the fraction soluble in xylene at 25° C. XSIV (A1) ranging from 1.50 to 3.00 dl/g, alternatively from 2.00 to 2.50 dl/g; or
a melt flow rate MFR(A1), measured according to the method ISO 1133-2:2011 at a temperature of 230° C., with a load of 2.16 Kg, ranging from 5 to 20 g/10 min., alternatively from 8 to 15 g/10 min.

In some embodiments, the heterophasic polymer composition (A) is prepared by melt blending components (a), (b), optionally (c), and optionally (d). In some embodiments, the heterophasic polymer composition (A) is prepared by polymerizing the relevant monomers in at least two polymerization stages, wherein the second and the optional subsequent polymerization stages are carried out in the presence of the polymer produced and the catalyst used in the immediately preceding polymerization stage, thereby obtaining a reactor-blend of the components (a), (b), and optionally (c). In some embodiments, the reactor-blend is optionally melt-blended with component (d).

In some embodiments, the heterophasic polymer composition (A) is a reactor blend of components (a), (b), and optionally (c).

In some embodiments, the monomers are polymerized in the presence of a catalyst selected from metallocene compounds, highly stereospecific Ziegler-Natta catalyst systems, and combinations thereof. In some embodiments, the monomers are polymerized in the presence of a highly stereospecific Ziegler-Natta catalyst system made from or containing:
(1) a solid catalyst component made from or containing a magnesium halide support on which a Ti compound having a Ti-halogen bond present, and a stereoregulating internal donor;
(2) optionally, an Al-containing cocatalyst; and
(3) optionally, an electron-donor compound (external donor).

In some embodiments, the solid catalyst component (1) is made from or containing TiCl₄ in an amount providing from 0.5 to 10% by weight of Ti with respect to the total weight of the solid catalyst component (1).

In some embodiments, the solid catalyst component (1) is made from or containing a stereoregulating internal electron donor compound selected from mono or bidentate organic Lewis bases. In some embodiments, the solid catalyst component (1) is made from or containing a stereoregulating internal electron donor compound selected from the group consisting of esters, ketones, amines, amides, carbamates, carbonates, ethers, nitriles, alkoxysilanes, and combinations thereof.

In some embodiments, the donors are esters of phthalic acids. In some embodiments, the esters of phthalic acids are as described in European Patent Application Nos. EP45977A2 and EP395083A2. In some embodiments, the esters of phthalic acids are selected from the group consisting of di-isobutyl phthalate, di-n-butyl phthalate, di-n-octyl phthalate, diphenyl phthalate, benzylbutyl phthalate, and combinations thereof.

In some embodiments, the esters of aliphatic acids are selected from the group consisting of esters of malonic acids, esters of glutaric acids, and esters of succinic acids. In some embodiments, the esters of malonic acids are as described in Patent Cooperation Treaty Publication Nos. WO98/056830, WO98/056833, and WO98/056834. In some embodiments, the esters of glutaric acids are as described in Patent Cooperation Treaty Publication No. WO00/55215. In some embodiments, the esters of succinic acids are as described in Patent Cooperation Treaty Publication No. WO00/63261.

In some embodiments, the diesters are derived from esterification of aliphatic or aromatic diols. In some embodiments, the diesters are as described in Patent Cooperation Treaty Publication No. WO2010/078494 and U.S. Pat. No. 7,388,061.

In some embodiments, the internal donor is selected from 1,3-diethers. In some embodiments, the 1,3-diethers are as described in European Patent Application Nos. EP361493 and EP728769 and Patent Cooperation Treaty Publication No. WO02/100904.

In some embodiments, mixtures of internal donors are used. In some embodiments, the mixtures are between aliphatic or aromatic mono or dicarboxylic acid esters and 1,3-diethers as described in Patent Cooperation Treaty Publication Nos. WO07/57160 and WO2011/061134.

In some embodiments, the magnesium halide support is magnesium dihalide.

In some embodiments, the amount of internal donor that remains fixed on the solid catalyst component (1) is 5 to 20% by moles, with respect to the magnesium dihalide.

In some embodiments, preparation of the solid catalyst component (1) is as described in European Patent Application No. EP395083A2.

In some embodiments, preparation of catalyst components is as described U.S. Pat. Nos. 4,399,054, 4,469,648, Patent Cooperation Treaty Publication No. WO98/44009A1, or European Patent Application No EP395083A2.

In some embodiments, the catalyst system is made from or containing an Al-containing cocatalyst (2). In some embodiments, the Al-containing cocatalyst (2) is selected from the group consisting of Al-trialkyls, alternatively the group consisting of Al-triethyl, Al-triisobutyl, and Al-tri-n-butyl. In some embodiments, the Al/Ti weight ratio in the catalyst system is from 1 to 1000, alternatively from 20 to 800.

In some embodiments, the catalyst system is further made from or containing electron donor compound (3) (external electron donor). In some embodiments, the electron donor compound (3) is selected from the group consisting of silicon compounds, ethers, esters, amines, heterocyclic compounds, and ketones. In some embodiments, the heterocyclic compound is 2,2,6,6-tetramethylpiperidine.

In some embodiments, the silicon compounds are selected from the group consisting of methylcyclohexyldimethoxysilane (C-donor), dicyclopentyldimethoxysilane (D-donor), and mixtures thereof.

In some embodiments, the polymerization to obtain the single components (a), (b) and optionally (c) or the sequential polymerization process to obtain the heterophasic polymer composition (A) is carried out in continuous or in batch. In some embodiments, the polymerization to obtain the single components (a), (b) and optionally (c) or the sequential polymerization process to obtain the heterophasic polymer composition (A) is carried out in liquid phase or in gas phase.

In some embodiments, the liquid-phase polymerization is in slurry, solution, or bulk (liquid monomer).

In some embodiments, the gas-phase polymerization is carried out in fluidized or stirred, fixed bed reactors or in a multizone circulating reactor. In some embodiments, the reactor is as described in European Patent Application No. EP1012195.

In some embodiments, the reaction temperature is in the range from 40° C. to 90° C. In some embodiments, the polymerization pressure is from 3.3 to 4.3 MPa for a process in liquid phase and from 0.5 to 3.0 MPa for a process in the gas phase.

In some embodiments, the polymerization processes for preparing the heterophasic polymer composition (A) are as described in Patent Cooperation Treaty Publication Nos. WO03/051984 and WO03/076511, which are herein incorporated by reference in their entirety.

In some embodiments, composition (B) is a multimodal polyethylene composition made from or containing an UHMWPE fraction (i) and a PE-wax (ii).

In some embodiments, the polyethylene composition (B) is made from or containing at least 75% by weight, alternatively at least 80% by weight, of (i)+(ii), wherein the amounts of (i) and (ii) are based on the total weight of the polyethylene composition (B), the total weight being 100%.

In some embodiments, the polyethylene composition (B) has a melt flow rate MFR(B), measured at 190° C. with a load of 2.16 Kg according to ISO 1133-2:2011, of up to and including 10 g/10 min, alternatively ranging from 0.00001 to 10 g/10 min.

In some embodiments, polyethylene composition (B) is made from or containing:
(i) 25-85% by weight, alternatively 60-75% by weight, of a polyethylene component, having a weight average molecular weight Mw(i), measured by Gel Permeation Chromatography, equal to or greater than 1,000,000 g/mol;
(ii) 10-65% by weight, alternatively 10-20% by weight, of a polyethylene component, having a weight average molecular weight Mw(ii), measured by Gel Permeation Chromatography, equal to or lower than 5,000 g/mol, and
(iii) up to and including 100% by weight of a polyethylene component different from component (i) and from component (ii),
wherein the polyethylene composition (B) is made from or containing at least 70% by weight, alternatively at least 75% by weight, alternatively at least 80% by weight, of (i)+(ii) and the amounts of (i) and (ii) are based on the total weight of the polyethylene composition (B), the total weight being 100%.

In some embodiments, the polyethylene composition (B) has a value of Mw/Mn(B) equal to or greater than 300, alternatively ranging from 300 to 1,500, wherein Mw and Mn are respectively the weight and the number average molecular weights of the polyethylene composition (B), measured by GPC.

In some embodiments, polyethylene components (i)-(iii) are independently selected from the group consisting of ethylene homopolymers, ethylene copolymers with an alpha-olefin of formula CH₂═CHR¹, wherein R¹ is a linear or branched C2-C8 alkyl, and mixtures thereof.

In some embodiments, the alpha-olefin is selected from the group consisting of butene-1, hexene-1,4-methyl-1-pentene, octene-1, and combinations thereof.

In some embodiments, the polyethylene components (i)-(iii) are ethylene homopolymers.

In some embodiments, the density, measured according to the method ASTM D 792-08, of the polyethylene components (i) and (ii) ranges from 0.900 to 0.965 g/cm³, alternatively from 0.930 to 0.960 g/cm³.

In some embodiments, polyethylene component (i) has at least one of the, alternatively has the, following properties:
a molecular weight distribution MWD(i) with a GPC peak (1) in the range from 1,000,000 to 3,000,000 g/mol, alternatively from 1,500,000 to 3,000,000 g/mol, wherein the MWD(i) is determined by Gel Permeation Chromatography; or
a Mw/Mn(i) value of up to and including 5, alternatively from 1.2 to 5, alternatively from 1.5 to 4.5, wherein Mn is the number average molecular weight measured by Gel Permeation Chromatography.

In some embodiments, polyethylene component (ii) has at least one of the, alternatively has the, following properties:
a MWD(ii) with a GPC peak (2) in the range from 500 to 1,500 g/mol, wherein the MWD(ii) is determined by Gel Permeation Chromatography; or
a Mw/Mn(ii) value of up to and including 5, alternatively from 1.2 to 5, alternatively from 1.5 to 4.5, wherein Mn is the number average molecular weight measured by Gel Permeation Chromatography.

In some embodiments, the polyethylene composition (B) is a multimodal polyethylene composition, wherein the MWD shows a GPC peak (1) in the range from 1,000,000 to 3,000,000 g/mol, alternatively from 1,500,000 to 3,000,000 g/mol, and a GPC peak (2) in the range from 500 to 1,500 g/mol.

In some embodiments, the polyethylene components (i)-(iii) are obtained by a polymerization process using single-site catalysts. In some embodiments, the UHMWPE component (i) is prepared as described in Patent Cooperation Treaty Publication Nos. WO01/021668 and WO2011/089017. In some embodiments, component (ii) is prepared as for polyethylenes, having low Mw values, as described in European Patent No. EP1188762.

In some embodiments, polyethylene component (iii) is obtained during the polymerization process to prepare the polyethylene component (i), the polyethylene component (ii), or both.

In some embodiments, polyethylene component (i) is prepared by polymerizing the relevant monomers with a polymerization catalyst made from or containing a cyclopentadienyl complex of chromium, alternatively η5-cyclopentadienyl moieties, alternatively [η⁵-3,4,5-trimethyl-1-(8-quinolyl)-2 trimethylsilyl-cyclopentadienyl-chromium dichloride (CrQCp catalyst component).

In some embodiments, polyethylene component (ii) is prepared by polymerizing the relevant monomers with a polymerization catalyst made from or containing a bis(imino)pyridine complex of chromium, alternatively 2,6-Bis-[1-(2,6-dimethylphenylimino)ethyl] pyridine chromium (III) trichloride (CrBIP catalyst component).

In some embodiments, the catalyst components are supported on a solid component. In some embodiments, the supports are finely divided supports. In some embodiments, the support is any organic or inorganic solid. In some embodiments, the inorganic support is selected from the group consisting of silica gel, magnesium chloride, aluminum oxide, mesoporous materials, aluminosilicates, hydrotalcites. In some embodiments, the organic support is selected from the group consisting of organic polymers or polymers bearing polar functional groups. In some embodiments, the organic polymers are selected from the group consisting of organic polymers such as polyethylene, polypropylene, polystyrene, polytetrafluoroethylene. In some embodiments, the polymers bearing polar functional groups are copolymers of ethylene and acrylic esters, acrolein, or vinyl acetate. In some embodiments, the support material has a specific surface area ranging from 10 to 1000 m²/g, a pore volume ranging from 0.1 to 5 ml/g, and a mean particle size of from 1 to 500 μm.

In some embodiments, the preparation of the supported catalyst is carried out by physisorption or by a chemical reaction, that is, by covalent binding of the components, with reactive groups on the surface of the support.

In some embodiments, the catalyst component is contacted with the support in a solvent, giving a soluble reaction product, an adduct, or a mixture.

In some embodiments, the support materials, the mode of preparation, and use for the preparation of supported catalyst are as described in Patent Cooperation Treaty Publication No. WO2005/103096.

In some embodiments, the catalyst components, alternatively CrQCp and CrBIP components, are contacted with an activator. In some embodiments, the activator is selected from the group consisting of alumoxanes and non-alumoxane activators.

In some embodiments, the alumoxanes are open-chain alumoxane compounds of the formula (1):

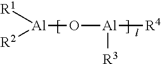

or cyclic alumoxane compounds of the formula (2):

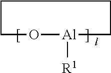

wherein R¹—R⁴ are independently selected from CT-C6 alkyl groups; alternatively selected from the group consisting of methyl, ethyl, n-butyl, and iso-butyl, and I is an integer from 1 to 40, alternatively from 4 to 25.

In some embodiments, the alumoxane is methylalumoxane (MAO).

In some embodiments, the non-alumoxane activators are selected from the group consisting of alkyl aluminums, alkyl aluminum halides, anionic compounds of boron or aluminum, trialkylboron and triarylboron compounds, and the like. In some embodiments, the non-alumoxane activators are selected from the group consisting of triethylaluminum, trimethylaluminum, tri-isobutylaluminum, diethylaluminum chloride, lithium tetrakis (pentafluorophenyl) borate, triphenylcarbenium tetrakis (pentafluorophenyl) borate, lithium tetrakis (pentafluorophenyl) aluminate, tris (pentafluorophenyl) boron, and tris (pentabromophenyl) boron.

In some embodiments, the activators are used in an amount within the range of 0.01 to 10,000, alternatively from 1 to 5,000, moles per mole of the single-site catalyst.

In some embodiments, the catalyst components are fed separately to the polymerization zone, supported on the supports during the preparation of the single-site catalyst or pre-contacted with the single-site catalyst.

In some embodiments, the polyethylene components (i)-(iii) are prepared in a single polymerization step by supporting the two single-site catalyst components on the same support, thereby obtaining a two-site catalyst component. In some embodiment, the two single-site catalyst components are CrQCp and CrBIP. In some embodiments, the two-site catalyst component supported on the same support provides a relatively close spatial proximity of the catalyst centers and an intimate mixing of the polyethylene components formed on each catalyst center

In some embodiments, polyethylene composition (B) is a reactor-blend of the polyethylene components (i)-(iii).

In some embodiments, the relative amounts of polyethylene components (i)-(iii) are obtained by setting the relative amounts of the two single-site catalyst components. In some embodiment, the two single-site catalyst components are CrQCp and CrBIP.

In some embodiments, the CrBIP/CrQCp molar ratio ranges from 0.1 to 20, alternatively from 0.3 to 10, alternatively from 0.5 to 8.

In some embodiments, the polyethylene components (i)-(iii) are produced separately by polymerizing the relevant monomers in the presence of the respective single-site catalysts and the polyethylene composition (B) is prepared by melt mixing the single components.

In some embodiments, the polyethylene components (i)-(iii) are prepared by gas-phase polymerization, solution polymerization, or suspension polymerization. In some embodiments, the polyethylene components (i)-(iii) are prepared in gas-phase fluidized-bed reactors. In some embodiments, the polyethylene components (i)-(iii) are prepared in loop reactors and stirred tank reactors. In some embodiments, the gas-phase polymerization is carried out in the condensed or super condensed mode, wherein part of the circulating gas is cooled to below the dew point and recirculated as a two-phase mixture to the reactor.

In some embodiments, the polyethylene components (i)-(iii) are produced in a gas-phase reactor, herein referred to as a “multizone circulating reactor (MZCR),” having two interconnected polymerization zones. The polymer particles flow upwards through a first polymerization zone, which is denominated “riser”, under fast fluidization or transport conditions, leave the riser, enter a second polymerization zone, which is denominated “downcomer”, through which the polymer particles flow in a densified form under the action of gravity. A continuous circulation of polymer is established between the riser and the downcomer. In some embodiments, a condition of fast fluidization is established in the riser by feeding a gas mixture made from or containing the monomers to the riser. In some embodiments, the catalyst system is fed to the reactor at a point of the riser.

In some embodiments, two polymerization zones with different composition are obtained by feeding a gas/liquid stream (barrier stream) to the upper part of the downcomer. In some embodiments, the gas/liquid stream acts as a barrier to the gas phase coming from the riser and establishes a net gas flow upward in the upper portion of the downcomer. In some embodiments, the established flow of gas upward prevents the gas mixture in the riser from entering the downcomer. In some embodiments, the reactor is as described in Patent Cooperation Treaty Publication No. WO 97/04015.

In some embodiments, the different or identical polymerization zones are connected in series, thereby forming a polymerization cascade. In some embodiments, the polymerization cascade is as described for the Hostalen® process. In some embodiments, a parallel reactor arrangement is used with two or more identical or different processes. In some embodiments, molar mass regulators or additives are used in the polymerizations. In some embodiments, the molar mass regulators are hydrogen. In some embodiments, the additives are antistatic agents.

In some embodiments, the polymerization temperatures are in the range from −20° to 115° C. In some embodiments, the pressure is in the range from 1 to 100 bar.

In some embodiments and in the case of suspension polymerizations, the suspension medium is an inert hydrocarbon, mixtures of hydrocarbons, or the monomers. In some embodiments, the inert hydrocarbon is isobutane. In some embodiments, the solids content of the suspension is in the range from 10 to 80%. In some embodiments, the polymerization is carried out batchwise or continuously. In some embodiments, the batchwise polymerization occurs in stirring autoclaves. In some embodiments, continuous polymerization occurs in tube reactors, alternatively in loop reactors.

In some embodiments, the polyethylene composition (B) is further made from or containing an additive (iv). In some embodiments, additive (iv) is selected from the group consisting of processing stabilizers, light stabilizers, heat stabilizers, lubricants, antioxidants, antiblocking agents, antistatic agents, pigments, dyes, and mixtures thereof. In some embodiments, the additive is present in the polyethylene composition (B) in an amount of up to and including 6% by weight, alternatively of from 0.1 to 1% by weight, based on the total weight of the polyethylene composition (B) made from or containing the additive, the total weight being 100%.

In some embodiments, the polyethylene composition (B) is free of a polymer other than polyethylene.

In some embodiments, the polyethylene composition (B) consists of the polyethylene components (i)-(iii) and, optionally, the further additive (iv).

In some embodiments, the polyolefin composition (I) optionally is further made from or containing up to and including, 40% by weight, alternatively 0.5-30% by weight, alternatively 1-20% by weight, of a component (C) selected from the group consisting of.
(C1) reinforcing agents;
(C2) saturated or unsaturated styrene or alpha-methylstyrene block copolymers;
(C3) polyolefins functionalized with a compound selected from the group consisting of maleic anhydride, C1-C10 linear or branched dialkyl maleates, C1-C10 linear or branched dialkyl fumarates, itaconic anhydride, C1-C10 linear or branched itaconic acid, dialkyl esters, maleic acid, fumaric acid, and itaconic acid;
(C4) an additive selected from the group consisting of pigments, dyes, extension oils, flame retardants, UV resistants, UV stabilizers, lubricants, antiblocking agents, slip agents, and waxes; and
(C5) combinations thereof,
wherein the amount of the further component (C) is based on the total weight of (A)+(B)+(C), the total weight being 100%. In some embodiments, the styrene-based copolymers (C2) are made from or containing up to and including 30% by weight, alternatively from 10% to 30% by weight, of styrene, based on the weight of (C2).

In some embodiments, the reinforcing agent (C1) is an inorganic reinforcing agent selected from the group consisting of inorganic fibers (such as glass fibers), mineral fillers (such as talc), and combinations thereof. In some embodiments, the reinforcing agent (C1) is glass fibers.

In some embodiments, the saturated or unsaturated styrene or alpha-methylstyrene block copolymer (C2) is made from or containing from 10% to 30% by weight of styrene, based on the weight of (C2). In some embodiments, (C2) is a styrene block copolymer selected from the group consisting of polystyrene-polybutadiene-polystyrene (SBS), polystyrene-poly(ethylene-butylene)-polystyrene (SEBS), polystyrene-poly(ethylene-propylene)-polystyrene (SEPS), polystyrene-polyisoprene-polystyrene (SIS), polystyrene-poly(isoprene-butadiene)-polystyrene (SIBS), and mixtures thereof. In some embodiments, the styrene block copolymer (C2) is a polystyrene-poly(ethylene-butylene)-polystyrene (SEBS).

In some embodiments, the styrene block copolymer (C2) has at least one of the, alternatively has the, following properties:
a melt flow rate (MFR), measured according to ASTM D1238 (230° C., 2.16 Kg), ranging from 5 to 80 g/10 min., alternatively from 10 to 60 g/10 min., alternatively from 10 to 30 g/10 min; or
a Shore A value, measured according to ASTM 2240 (30 sec.), equal to or lower than 70, alternatively ranging from 30 to 70, alternatively from 30 to 60.

In some embodiments, styrene or alpha-methylstyrene block copolymers (C2) are prepared by ionic polymerization and are commercially available under the tradename of Kraton™ from Kraton Polymers.

In some embodiments, the functionalized polyolefin (C3) is selected from polyethylenes, polypropylenes, and mixtures thereof, functionalized with a compound selected from the group consisting of maleic anhydride, C1-C10 linear or branched dialkyl maleates, C1-C10 linear or branched dialkyl fumarates, itaconic anhydride, C1-C10 linear or branched itaconic acid, dialkyl esters, maleic acid, fumaric acid, itaconic acid, and mixtures thereof.

In some embodiments, the functionalized polyolefin (C3) is a polyethylene, a polypropylene, or both grafted with maleic anhydride (MAH-g-PP, MAH-g-PE, or both).

In some embodiments, the functionalized polyolefins are produced by functionalization processes carried out in solution, in the solid state, or in the molten state. In some embodiments, the molten state functionalization is achieved by reactive extrusion of the polymer in the presence of the grafting compound and of a free radical initiator. In some embodiments, the functionalization of polypropylene, polyethylene, or both with maleic anhydride is as described in European Patent Application No. EP0572028A1.

In some embodiments, the functionalized polyolefins are commercially available under the tradenames Amplify™ TY from The Dow Chemical Company, Exxelor™ from ExxonMobil Chemical Company, Scona® TPPP from Byk (Altana Group), Bondyram® from Polyram Group, and Polybond® from Chemtura. In some embodiments, the functionalized polyolefins are combinations thereof.

In some embodiments, polyolefin composition (I) is produced by mixing the components (A), (B), and optionally (C). In some embodiments, polyolefin composition (I) is produced by mixing the components (A), (B), and optionally (C) by compounding components at a temperature of from 180° to 220° C.

In some embodiments, the present disclosure provides a process for manufacturing a shaped article including a step of subjecting a flow of the molten polyolefin composition (I) to a shear rate equal to or greater than 50 s⁻¹, alternatively equal to or greater than 150 s⁻¹, thereby improving the tensile properties of the heterophasic polymer composition (A).

In some embodiments, the flow of the molten polyolefin composition (I) is subjected to a strain rate equal to or greater than 3 s⁻¹, alternatively equal to or greater than 8 s⁻¹.

In some embodiments, the present disclosure provides a manufacturing process including the steps of.
melting the polyolefin composition (I) at a temperature equal to or greater than 180° C., alternatively ranging from 180° C. to 220° C.;
subjecting a flow of the molten polyolefin composition (I) to a shear rate equal to or greater than 50 s⁻¹, alternatively equal to or greater than 150 s⁻¹; and
shaping and cooling the molten polyolefin composition (I).

In some embodiments, the step of subjecting a flow of the molten polyolefin composition (I) to a shear rate equal to or greater than 50 s⁻¹ is carried out by injection molding or by an extrusion-based process.

In some embodiments, the step of subjecting a flow of the molten polyolefin composition (I) to a shear rate equal to or greater than 50 s⁻¹ is carried out by injection molding, wherein the shear rate ranges from 50 to 3,000 s⁻¹, alternatively from 200 to 2,000 s⁻¹.

In some embodiments and in the injection molding process, the flow of the molten polyolefin composition (I) is subjected to a strain rate ranging from 3 to 200 s⁻¹, alternatively from 8 to 120 s⁻¹.

In some embodiments, the injection molding process is carried out by melt mixing the polyolefin composition (I) in a twin-screw extruder, alternatively a twin-screw co-rotating extruder.

In some embodiments, the components of the polyolefin composition (I) are fed to the injection molding machine separately or pre-mixed, alternatively pre-mixed in the molten state. In some embodiments, pre-mixing in the molten state is accomplished by compounding the components of the polyolefin composition (I) in a compounder.

In some embodiments, the extrusion-based process is an extrusion-based 3D printing process, wherein the step of subjecting a flow of the molten polyolefin composition (I) to a shear rate equal to or greater than 50 s⁻¹ is carried out by extrusion-based 3D printing and the shear rate ranges from 50 to 1,000 s⁻¹, alternatively from 100 to 600 s⁻¹.

In some embodiments, the extrusion-based 3D printing process includes the step of subjecting the flow of the molten polyolefin composition (I) to a strain rate ranging from 3 to 50 s⁻¹, alternatively from 3 to 20 s⁻¹.

In some embodiments, the 3D printing process is a Fused Filament Fabrication (FFF) process, referred to herein as “Fused Deposition Modeling (FDM).”

In some embodiments, the components of the polyolefin composition (I) are fed to the 3D printer separately or pre-mixed, alternatively pre-mixed in the molten state. In some embodiments, pre-mixing in the molten state is accomplished by compounding the components of the polyolefin composition (I) in a compounder.

In some embodiments, the present disclosure provides a filament for extrusion-based 3D printing made from or containing a polyolefin composition (I). In some embodiments, a filament for extrusion-based 3D printing consists of a polyolefin composition (I). As used herein, the term “extrusion-based additive manufacturing” refers to extrusion-based 3D printing with a filament.

In some embodiments, the present disclosure provides polyethylene composition (B) as a reinforcing masterbatch for the heterophasic polymer composition (A).

In some embodiments, the present disclosure provides a method for reinforcing heterophasic polymer composition (A) with polyolefin composition (B) including the steps of:
adding 20-85% by weight, alternatively 20-60% by weight, alternatively 30-50% by weight, of the polyethylene composition (B) to 15-80% by weight, alternatively 40-80% by weight, alternatively 50-70% by weight, of the heterophasic polymer composition (A), thereby obtaining a polyolefin composition (I), wherein the amounts of (A) and (B) are based on the total weight of (A)+(B);
melting the polyolefin composition (I) at a temperature equal to or greater than 180° C. and subjecting a flow of the molten polyolefin composition (I) to a shear rate equal to or greater than 50 s⁻¹, alternatively equal to or greater than 150 s⁻¹; and
shaping and cooling the molten polyolefin composition (I).

In some embodiments, the step of cooling the molten polyolefin composition includes the step of shaping the polyolefin composition by an extrusion-based process or by injection molding. In some embodiments, the extrusion-based process is 3D printing.

The features describing the subject matter of the present disclosure are not inextricably linked to each other. In some embodiments, a level of a feature does not involve the same level of the remaining features of the same or different components. In some embodiments, a range of features of components (A) and (B) is combined independently from the level of other components. In some embodiments, components (A) and (B) are combined with an additional component, having features as described in the present disclosure.

### EXAMPLES

The following examples are illustrative and not intended to limit the scope of the disclosure in any manner whatsoever.

### Characterization Methods

The following methods are used to determine the properties indicated in the description, claims, and examples.

Melt Flow Rate: determined according to the method ISO 1133-2:2011, at a temperature of 230° C. or of 190° C. depending on the polymer and with a load of 2.16 Kg. The melt flow rate of a composition (MFR(tot)) is related to the melt flow rates of the components by the formula:

$$log MFR ( tot ) = {\sum }_{i} w ( i ) log MFR ( i )$$

wherein
w(i) is the weight fraction of component i in the composition and MFR(i) is the melt flow rate of the component i.

Density: measured according to the method ASTM D 792-08.

Solubility in xylene at 25° C.: 2.5 g of polymer sample and 250 ml of xylene are introduced into a glass flask equipped with a refrigerator and a magnetic stirrer. The temperature was raised in 30 minutes up to 135° C. The resulting clear solution was kept under reflux and stirred for further 30 minutes. The solution was cooled in two stages. In the first stage, the temperature was lowered to 100° C. in air for 10 to 15 minutes under stirring. In the second stage, the flask was transferred to a thermostatically controlled water bath at 25° C. for 30 minutes. The temperature was lowered to 25° C., without stirring during the first 20 minutes, and maintained at 25° C., with stirring for the last 10 minutes. The formed solid was filtered on quick filtering paper (for example, Whatman filtering paper grade 4 or 541). 100 ml of the filtered solution (S1) was poured into a pre-weighed aluminum container, which was heated to 140° C. on a heating plate under nitrogen flow, thereby removing the solvent by evaporation. The container was then kept in an oven at 80° C. under vacuum until a constant weight was reached. The amount of polymer soluble in xylene at 25° C. was then calculated.

The xylene soluble fraction of a composition (XS(tot)) is related to the xylene soluble fraction of the components by the following formula:

$$XS ( tot ) = {\sum }_{i} w ( i ) XS ( i )$$

wherein w(i) is the weight fraction of component i in the composition, and XS(i) is the xylene soluble fraction of the component i.

C2 and C4 content in polymers containing C3, C2 and C4: ¹³C NMR spectra were acquired on a Bruker AV-600 spectrometer equipped with cryoprobe, operating at 160.91 MHz in the Fourier transform mode at 120° C. The peak of the S_{δδ} carbon (nomenclature according to “Monomer Sequence Distribution in Ethylene-Propylene Rubber Measured by 13C NMR. 3. Use ofReaction Probability Mode” C. J. Carman, R. A. Harrington and C. E. Wilkes, Macromolecules, 1977, 10, 536) was used as an internal standard at 29.9 ppm.

About 30 mg of sample were dissolved in 0.5 ml of 1,1,2,2-tetrachloroethane-d2 at 120° C. added with 0.1 mg/ml of Irganox 1010 (AO1010) as antioxidant. Each spectrum was acquired with a 90° pulse, and 15 seconds of delay between pulses and CPD, thereby removing 1H-13C coupling. 512 transients were stored in 65K data points using a spectral window of 9000 Hz. Triad distribution was made using the following equations (possible overlaps with peaks originating from A01010 were considered):

$$PPP = 100 {I}_{19} / Σ$$

$$PPE = 100 {I}_{13} / Σ$$

$$EPE = 100 {I}_{11} / Σ$$

$$BBB = 100 {I}_{8} / Σ$$

$$BBE = 100 {I}_{7} / Σ$$

$$EBE = 100 {I}_{3} / Σ$$

$$XEX = 100 {I}_{21} / Σ$$

$$XEE = 100 ( {I}_{6} + {I}_{10} ) / Σ$$

$$EEE = 100 ( 0.5 {I}_{17} + 0.25 ( {I}_{16} + {I}_{15} ) ) / Σ$$

wherein Σ=I₁₉+I₁₃+I₁₁+I₈+I₇+I₃+I₂₁+I₆+I₁₀+0.5 I₁₇+0.25 (I₁₆+I₁₅), Ii are the areas of the corresponding carbons as reported in the table below and X is either propylene or butene-1.

| Number | Chemical Shift (ppm) | Carbon | Sequence |
|---|---|---|---|
| 1 | 47.1-45.5 | S_{αα} | PP |
| 2 | 40.2-39.1 | S_{αα} | BB |
| 3 | 39.6 | T_{δδ} | EBE |
| 4 | 39.1 | S_{αα} | BB |
| 5 | 38.2-37.6 | S_{αγ} | PPE |
| 6 | 37.6-37.2 | S_{αδ} | PEE |
| 7 | 37.3-37.0 | T_{βδ} | BBE |
| 8 | 35.3-34.9 | T_{ββ} | BBB |
| 9 | 34.9-34.3 | S_{αγ} | BBE |
| 10 | 34.3-34.0 | S_{αδ} | BEE |
| 11 | 33.3-33.2 | T_{δδ} | EPE |
| 12 | 30.9 | S_{γγ} | BEEB |
| 13 | 30.9-30.8 | T_{βδ} | PPE |
| 14 | 30.8-30.6 | S_{γγ} | PEEP |
| 15 | 30.5-30.4 | S_{γδ} | BEEE |
| 16 | 30.3 | S_{γδ} | PEEE |
| 17 | 29.9 | S_{δδ} | EEE |
| 18 | 28.8-28.3 | T_{ββ} | PPP |
| 19 | 27.6-26.9 | S_{βδ} + 2B₂ | BE, PE, BBE |
| 20 | 26.7 | 2B₂ | EBE |
| 21 | 24.8-24.1 | S_{ββ} | XEX |
| 22 | 21.9-20.0 | CH₃ | P |
| 23 | 11.3-10.8 | CH₃ | B |

The molar content of ethylene, propylene, and butene-1 was calculated from triads using the following equations:

$$[ E ] mol \% = EEE + XEE + XEX$$

$$[ P ] mol \% = PPP + PPE + EPE$$

$$[ B ] mol \% = BBB + BBE + EBE$$

The molar content was converted into weight content using the molecular weights of the monomers.

C2 and C3 in polymers containing propylene and ethylene: ¹³C NMR spectra were acquired on a Bruker AV-600 spectrometer equipped with cryoprobe, operating at 160.91 MHz in the Fourier transform mode at 120° C. The peak of the S66 carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as an internal standard at 29.9 ppm.

About 30 mg of sample were dissolved at 120° C. in 0.5 ml of 1,1,2,2-tetrachloroethane-d2 added with 0.1 mg/ml of Irganox 1010 (A01010) as antioxidant. Each spectrum was acquired with a 90° pulse, 15 seconds of delay between pulses and CPD, thereby removing 1H-13C coupling. 512 transients were stored in 32K data points using a spectral window of 9000 Hz. The assignments of the spectra, the evaluation of triad distribution and the composition were made according to M. Kakugo, Y. Naito, K. Mizunuma and T. Miyatake, Macromolecules, 1982, 15, 4, 1150-1152 using the following equations (possible overlaps with peaks originating from AO1010 were considered):

$$PPP = 100 {T}_{β β} / S$$

$$PPE = 100 {T}_{βδ} / S$$

$$EPE = 100 {T}_{δδ} / S$$

$$PEP = 100 {S}_{β β} / S$$

$$PEE = 100 {S}_{βδ} / S$$

$$EEE = 100 ( 0.25 {S}_{γδ} + 0.5 {S}_{δδ} ) / S$$

$$S = {T}_{β β} + {T}_{βδ} + {T}_{δδ} + {S}_{β β} + {S}_{βδ} + 0.25 {S}_{γδ} + 0.5 {S}_{δδ}$$

The molar content of ethylene and propylene was calculated from triads using the following equations:

$$[ E ] mol = EEE + PEE + PEP$$

$$[ P ] mol = PPP + PPE + EPE$$

The molar content was converted into weight content using the molecular weights of the monomers.

Molecular weight properties: The average molecular weights Mw and Mn, and the molecular weight distributions were determined by Gel Permeation Chromatography (GPC) on a PL-220 high temperature gel permeation chromatographer (HT-GPC Agilent) equipped with three PLGel Olexis columns and a triple-detection system (differential refractive index detector, differential viscometer 210 R(Viskotek), low-angle light scattering). The columns were calibrated using 12 monodisperse polystyrene standards (Agilent Technologies) with narrow molecular weight distribution, in the range from 580 g/mol to 11,600,000 g/mol. The calibration curve was adapted to polyethylene (Grubisic Z., Rempp P and Benoit H., J. Polymer Sci., 5, 753 (1967)). The Mark-Houwink parameters used for polystyrene kPS=0.000121 dl/g, αPS=0.706 and for polyethylene kPE=0.000406 dl/g, αPE=0.725, valid in TCB at 135° C. Data recording, calibration, and calculation were carried out using NTGPC_Control_V6.02.03 and NTGPC_V6.4.24 (hs GmbH, Hauptstrasse 36, D-55437 Ober-Hilbersheim, Germany) respectively. Sample measurements were operated at 160° C. in 1,2,4-trichlorobenzene (stabilized with 0.2 wt.-% 2,6-di-tert-butyl-(4-methylphenol, BHT)) at a flow rate of 1.0 mL/min, injection volume of 500 μL, and polymer concentration from 0.01% to 0.05% w/w.

Injection molding of the test specimens: The tensile and impact test specimens were prepared by injection molding the compositions with a DSM Xplore Micro Compounder 5 cc equipped with the injection molding system DSM Xplore 10 cc at 220° C., 0.8 MPa and 8 sec. of holding pressure. Mold temperature was 60° C.

Compression molding: Plates 110×80×2 and 4 mm were obtained with a compression molding system Collin 200P, operated at 200° C., 0.8 MPa with a holding time of 20 min. Tensile test specimens of ISO 527-2:2012, Type 5A geometry were cut from plates 2 mm-thick plates. Impact test specimens of ISO 179-1/1 eA were cut from 4 mm-thick plates.

Tensile properties at break: The tensile modulus and the tensile strength were measured according to the method ISO 527-1:2012, with a tensile test machine ZWICK Z005, makroXtens extensiometer (load cell 2.5 kN). Six test specimens of ISO 527-2:2012, Type 5A geometry were tested for each composition, with a pulling speed of 50 mm/min. The data were evaluated with the software TESTXPERT II V3.31. The mean value of the six measurements was taken as the value of the tested property.

Impact test: The Charpy impact strength was measured on test specimens ISO 179-1/1 eA, according to the method ISO 179-1:2010 (notched impact at 23° C.) with an impact test machine Zwick 5102.100/00 pendulum impact tester. Five test specimens were tested for each composition. The specimens were impacted after determination of the cross sectional area at the notch. The characteristics of the impact test were determined from the dissipated energy. The mean value of five measurements was taken as the value of the impact test resistance.

Shear rate: The shear rate \dot{γ} applied to the polymer melt during extrusion was calculated by the following formula:

$$\dot{y} = \frac{4 \cdot \dot{V}}{π \cdot {R}_{L}^{3}}$$

wherein R_{L} indicates the radius of the die or nozzle (unit:mm) and \dot{V} is the volumetric flow (unit:mm³/s) of the polymer. The volumetric flow \dot{V} was measured for the specific combination of 3D printer, nozzle diameter, temperature, and printing speed (that is, extrusion speed). The polymer throughput m (unit:g/s) was measured gravimetrically and divided by the polymer melt density p (unit:g/mm³) according to the following equation: \dot{V}=\dot{m}/p.

Strain rate: The strain rate k applied to the polymer melt during extrusion was calculated by the following formula:

$$\dot{ε} = \frac{\dot{V}}{π \cdot L} ( \frac{1}{{R}_{L}^{2}} - \frac{1}{{R}_{0}^{2}} )$$

wherein \dot{V} is the volumetric flow (unit:mm³/s) of the polymer, L indicates the length of the convergent zone of the die or nozzle (unit:mm), R_{L} indicates the radius of the die or nozzle at the outlet of the convergent zone (unit:mm), and R₀ indicates the radius of the die or nozzle at the inlet of the convergent zone (unit:mm). The volumetric flow \dot{V} was measured for the specific combination of 3D printer, nozzle diameter, temperature, and printing speed (that is, extrusion speed). The polymer throughput m (unit:g/s) was measured gravimetrically and divided by the polymer melt density p (unit:g/mm³) according to the following equation: \dot{V}=\dot{m}/p

### Raw Materials:

HECO-1—an heterophasic polymer made from or containing (based on the total weight of (a)+(b)+(c)):
(a) 56.5 wt. % of a propylene homopolymer, having a xylene soluble fraction XS(a) of 3 wt. %, based on the weight of (a), and an MFR(a) of 70 g/10 min. (ISO 1133-2:2011, 230° C./2.16 Kg);
(b) 23.0 wt. % of a copolymer of ethylene and butene-1, having 27.4 wt. % of units deriving from butene-1, based on the weight of (b); and
(c) 20.5 wt. % of a propylene-ethylene copolymer, having 41.5 wt. % of ethylene-deriving units, based on the weight of (c).

The HECO-1 was a reactor blend of components (a), (b), and (c) obtained as described in examples 1-3 of the Patent Cooperation Treaty Publication No. WO03/076511A1, having the following properties:
a fraction soluble in xylene at temperature of 25° C. XS(HECO-1) of 35.2 wt. %;
an intrinsic viscosity of the fraction soluble in xylene at 25° C. XSIV(HECO-1) of 2.26 dl/g;
a melt flow rate MFR(HECO-1), measured according to the method ISO 1133 at a temperature of 230° C., with a load of 2.16 Kg, of 12.5 g/10 min; and
a total ethylene content of 25.2 wt. % and a total butene-1 content of 6.3 wt. %, based on the weight of (a)+(b)+(c).

The amounts of (a), (b), and (c) corresponded to the splits of the reactors. The amount of ethylene in component b) and in component c) and the amount of butene-1 in component (c) were calculated from the total amounts of ethylene C2 (tot) and butene-1 C4 (tot), measured on the HECO-1, using the following formulas:

$$C 2 ( tot ) = w ( b ) C 2 ( b ) + w ( c ) C 2 ( c )$$

$$C 4 ( t o t ) = w ( b ) C 4 ( b )$$

$$C 2 ( b ) = 100 - w ( b ) C 4 ( b )$$

wherein w(b) and w(c) are the weight fractions of components (b) and (c) in HECO-1, C2 (b) and C2 (c) are the amounts of ethylene in components (b) and (c), and C4 (b) is the amount of butene-1 in component (b).

Component B: The polyethylene composition was prepared as described in the Patent Cooperation Treaty Publication No. WO2020/169423A1 for composition 11-2.

2,6-Bis-[1-(2,6-dimethylphenylimino)ethyl] pyridine chromium (III) trichloride (CrBIP) was synthesized as described in Esteruelas M A, et al. Organometallics 2003; 22(3):395-406. [η⁵-3,4,5-trimethyl-1-(8-quinolyl)-2 trimethylsilyl-cyclopentadienyl-chromium dichloride (CrQCp) was synthesized as described in Enders et al. Organometallics 2004; 23(16):3832-9, and Femindez et al. Organometallics 2007; 26(18):4402-12.

### Preparation of the Mixed Catalyst System

The mesoporous silica catalyst support (Sylopol XP02107 of Grace), exhibiting a pore volume of 1.5 ml/g and a specific surface of 400 m² g⁻¹, was dried in a Schlenk-tube in high-vacuum (10⁻³ bar) at 160° C. for 14 h. 20 mL of toluene were added. The suspension was sonicated for 10 min. After adding the calculated amount of MAO (Al:Cr=300:1), the mixture was stirred for 30 min and sonicated for 5 min. After sedimentation, the MAO-treated catalyst support was washed with dry toluene by removal and exchange of the supernatant. CrBIP was dissolved in toluene (0.2 mg mL⁻¹), pretreated with trimethylaluminum (TMA, 10 equiv.), and added by syringe. After stirring for 5 min, CrQCp in toluene (0.2 mg mL⁻¹) was also added. The mixture was stirred again for 5 min. The CrBIP/CrQCp molar ratio was 3.0. After sedimentation, the activated catalyst was collected in n-heptane (20 mL) and transferred into the reactor. The polymerization was started. Ethylene polymerization was carried out in a 2.6 L steel reactor (HITEC ZANG), equipped with a mechanical stirrer, a thermostat, and a software interface. The reactor was heated in high-vacuum at 90° C. for 2 h, filled with n-heptane (580 mL) and tri-isobutylaluminum (TiBAl, 3 mL, 1 M in n-hexane), and saturated with ethylene (5 bar). After transferring the prepared catalyst into the reactor, the polymerization was proceeded at 40° C., an ethylene pressure of 5 bar, and a stirring speed of 200 rpm for 120 min. The polymer was stabilized with BHT (2,6-Di-tert-butyl-4-methylphenol) in methanol, filtered, and dried under reduced pressure at 60° C. to a constant weight.

The properties of the polyethylene composition are reported in Table 1.

TABLE 1

| | | | GPC | | Mw/ |
|---|---|---|---|---|---|
| | | Mw | peak | Mw/ | Mn |
| Comp. | wt. % | g/mol | g/mol | Mn | of (B) |
| (i) | 63 | 2,000,000 | 1,200,000 | 4 | >500 |
| (ii) | 17 | 1,000 | 800 | 4 | |
| (iii) | 20 | — | — | — | |

HECO-2 (Comparative)—an heterophasic polyolefin composition made from or containing
(a) 60 wt. % of propylene homopolymers; and
(b) 40 wt. % of a propylene-ethylene copolymer, having 68 wt. % of ethylene, based on the weight of (b).

The HECO-2 was a reactor-blend of components (a) and (b) obtained as described in examples 1-2 of Patent Cooperation Treaty Publication No. WO2005/014715 and having the following properties:
a fraction soluble in xylene at temperature of 25° C. XS(HECO-2) of 31.2 wt. %;
an intrinsic viscosity of the fraction soluble in xylene at 25° C. XSIV(HECO-2) of 2.29 dl/g; and
a melt flow rate MFR(HECO-1), measured according to the method ISO 1133 at a temperature of 230° C., with a load of 2.16 Kg, of 11.3 g/10 min.

The amount of ethylene C2 (b) in component (b) was calculated from the total amount of ethylene C2 (tot) measured on the HECO-2, using the following formula:

C2(tot)=w(b)C2(b)

wherein w(b) is the weight fraction of component (b) in HECO-2, C2 (b) and C2 (b) is the amount of ethylene in component (b).

Metocene MF650Y—a propylene homopolymer, having a very narrow molecular weight distribution and MFR (ISO 1133, 230° C./2.16 Kg) of 1800 g/10 min, was commercially available from LyondellBasell.

Kraton™ G1657V a linear styrene triblock copolymer, based on styrene and ethylene/butylene, having 13 wt. % of polystyrene, a MFR (ASTM D1238; 230° C., 5 Kg) of 22 g/10 min., and a Shore A value (ASTM D2240, 10 sec.) of 47, was commercially available from Kraton Corp.

Engage 7467 an ethylene-butene copolymer, having 31 wt. % of units deriving from butene-1, a density of 0.862 g/cm³ (ASTM D792), and a melt index (ASTM D1238, 190° C./2.16 Kg), was commercially available from Dow.

Polybond 3200—a maleic anhydride modified polypropylene homopolymer, having a maleic anhydride content ranging from 0.8 to 1.2 wt. % (ASTM D6047) and a MFR of 115 g/10 min. (ASTM D1238, 190° C./2.16 Kg), was commercially available from SI Group.

Moplen HP500N—a propylene homopolymer, having a MFR of 12 g/10 min., measured according to the method ISO 1133 at a temperature of 230° C., with a load of 2.16 Kg, was commercially available from LyondellBasell.

GF—Glass Fibers ThermoFlow. 636 EC10 (diameter: 10 μm; length: 4 mm), was commercially available from Johns Manville.

Additive pack was made from or containing 5.0 wt. % of Irgafos 168 tris(2,4-di-tert-butylphenyl)phosphite, 7.5 wt. % Irganox 1076 octadecyl-3-[3,5-di-tert-butyl-4-hydroxyphenyl]propionate, 2.5 wt. % Tinuvin 622 oligomeric hindered amine light stabilizer, 12.5 wt. % talc, 25 wt. % polydimethylsiloxane, 2.5 wt. % magnesium oxide, and 45 wt. % of Moplen HF501N, wherein the amounts were based on the weight of the additive pack. Irgafos 168, Irganox 1076, and Tinuvin 622 were commercially available from BASF. Moplen HF501N was commercially available from LyondellBasell.

### Example E1 and Comparative Examples CE2-CE5

The components were melt-mixed in a DSM Xplore Compounder 5 cc at 200° C., 120 rpm and 90s holding time, pelletized, and injection molded.

The compositions of the tested specimens and the tests results for tensile and impact properties are reported in Table 2.

TABLE 2

| | | E1 | CE2 | CE3 | CE4 | CE5 |
|---|---|---|---|---|---|---|
| HECO-1 | wt. % | 60 | 100 | 75 | — | — |
| HECO-2 | wt. % | — | — | — | 100 | 50 |
| Comp. (B) | wt. % | 40⁽*⁾ | — | — | — | 50⁽**⁾ |
| GF | wt. % | — | — | 25 | — | — |
| Tensile modulus | MPa | 1,800 | 700 | 2,290 | 1,260 | 730 |
| Tensile strength | MPa | 47.5 | 17.1 | 37.2 | 21.1 | 22.0 |
| Notched Charpy | KJ/m² | 41 | 55 | 27 | 12.9 | 6.3 |
| impact strength | | | | | | |
| Density | g/cm² | 0.91 | 0.89 | 1.10 | 0.90 | 0.93 |

the amount of UHMWPE fraction (B)(i) in the polyolefin composition is:
⁽*⁾25.2 wt. % and
⁽**⁾31.5 wt. %, based on the total weight of the composition (B).

### Examples E6-E9 and Comparative Examples CE10 and CE11

The components were melt-mixed in a DSM Xplore Compounder 5 cc at 200C, 120 rpm and 90s holding time and pelletized. The pellets were injection molded into the test specimens. The compositions of the tested specimens and the tests results for tensile and impact properties are reported in Table 3.

TABLE 3

| | | | E6 | E7 | E8 | E9 | CE10 | CE11 |
|---|---|---|---|---|---|---|---|---|
| Component (A) | HECO-1 | wt. % | 39.2 | 29.4 | 24.5 | 9.8 | 36.8 | 49 |
| | MF650Y | wt. % | 15.2 | 11.4 | 9.5 | 3.8 | 14.2 | 19 |
| | Engage | wt. % | 15.2 | 11.4 | 9.5 | 3.8 | 14.2 | 19 |
| | 7467 | | | | | | | |
| Component (B) | | wt. % | 20.0 | 40.0 | 50.0 | 80.0 | — | — |
| GF | | wt. % | — | — | — | — | 25.0 | — |
| Component (C) | Kraton | wt. % | 5.6 | 4.2 | 3.5 | 1.4 | 5.2 | 7 |
| | G1657V | | | | | | | |
| | Polybond | wt. % | 0.8 | 0.6 | 0.5 | 0.2 | 0.8 | 1 |
| | 3200 | | | | | | | |
| | Additive | wt. % | 4.0 | 3.0 | 2.5 | 1.0 | 3.8 | 5 |
| | pack | | | | | | | |
| Tensile modulus | | MPa | 795 | 2,100 | 2,500 | 3,700 | 2,130 | 650 |
| Tensile strength | | MPa | 32.7 | 72.0 | 88.0 | 115.0 | 31.9 | 18.2 |
| Notched Charpy | | KJ/m² | 45.6 | 44.2 | 41.0 | 82.7 | 29.3 | 54.8 |
| impact strength | | | | | | | | |
| Density | | g/cm² | 0.91 | 0.92 | 0.93 | 0.94 | 1.10 | 0.90 |

### Comparative Examples CE12 and CE13

The components were melt-mixed in a DSM Xplore Compounder 5 cc at 200° C., 120 rpm and 90s holding time and pelletized. Test specimens were obtained by compression molding of the pellets. The compositions of the tested specimens and the tests results are reported in Tables 4 and 4a.

TABLE 4

| | | | CE12 | CE13 |
|---|---|---|---|---|
| Component (A) | HECO-1 | wt. % | 49 | 24.5 |
| | MF650Y | wt. % | 19 | 9.5 |
| | Engage 7467 | wt. % | 19 | 9.5 |
| Component (B) | | wt. % | — | 50.0 |
| Component (C) | Kraton G1657V | wt. % | 7 | 3.5 |
| | Polybond 3200 | wt. % | 1 | 0.5 |
| | Additive pack | wt. % | 5 | 2.5 |

TABLE 4a

| | | CE12 | CE13 |
|---|---|---|---|
| Tensile modulus | MPa | 400 | 600 |
| Tensile strength | MPa | 16.9 | 19.0 |
| Notched Charpy | KJ/m² | 46.0 | 32.0 |
| impact strength | | | |
| Density | g/cm² | 0.90 | 0.93 |

### Example E14 and Comparative Example CE15

The compositions of example E8 and of comparative example CE10 were subjected to four process cycles of granulating and injection molding in a DSM Xplore Micro Compounder 5 cc equipped with the injection molding system DSM Xplore 10 cc at 220° C., 0.8 MPa and 8 sec. of holding pressure (mold temperature of 60° C.).

The values of tensile modulus and tensile strength measured at the end of each process cycle are reported in Table 5.

TABLE 5

| | | Tensile | Tensile |
|---|---|---|---|
| | Process | Modulus | Strength |
| | cycles | [MPa] | [MPa] |
| E14 | 1 | 2,500 | 88 |
| (composition E8) | 2 | 2,600 | 89 |
| | 3 | 2,700 | 87 |
| | 4 | 2,600 | 88 |
| | 5 | 2,600 | 89 |
| CE15 | 1 | 2,130 | 31.9 |
| (composition CE10) | 2 | 1,920 | 28.9 |
| | 3 | 1,830 | 25.3 |
| | 4 | 1,820 | 24.7 |
| | 5 | 1,740 | 22.8 |

### Examples E16-E18 and Comparative Examples CE19-CE21

The pellets of the composition produced in example E8 and of the composition produced in example CE10 were extruded on a twin-screw extruder COLLIN TEACH-LINE™ ZK 25T with a round die (3.00 mm diameter), thereby obtaining a filament for 3D printing. The extrusion parameters are reported in Table 6. The extruded filament was water cooled and rolled up on printer coils.

TABLE 6

| Parameter | |
|---|---|
| T _{Zone 1} [° C.] | 190 |
| T _{Zone 2} [° C.] | 190 |
| T _{Zone 3} [° C.] | 180 |
| T _{Zone 4} [° C.] | 175 |
| Revolutions [Number/min] | 20 |
| Feed Rate [kg/h] | 2.0 |
| Output [mm/s] | 60 |

The 3D printed parts were produced with an Ultimaker 2+ FFF printer using 100% infill and a nozzle of 0.8 mm diameter. The printing parameters are reported in Table 7.

TABLE 7

| Material | |
|---|---|
| Build plate material | Scotch Tape |
| Nozzle diameter mm | 0.8 |
| Line width [mm] | 0.7 |
| Layer height [mm] | 0.2 |
| Nozzle temperature [° C.] | 210 |
| Build plate temperature [° C.] | 60 |
| Printer speed [mm/s] | 25,100, or 150 |
| Infill pattern | lines |

Specimens for tensile tests and Charpy impact tests were prepared by 3D printing the filaments with a filling pattern orientation parallel to the longest dimension of the test specimens, corresponding to a 0° orientation relative to the pulling/impact direction.

The values of the tensile modulus and of the tensile strength measured for each printing/extrusion speed and the associated shear and strain rates to which the polymer melt was subjected in the process are reported in Table 8.

TABLE 8

| | | E16 | E17 | E18 | CE19 | CE20 | CE21 |
|---|---|---|---|---|---|---|---|
| Printing speed | mm/s | 25 | 100 | 150 | 25 | 100 | 150 |
| Shear rate | 1/s | 110 | 260 | 450 | — | — | — |
| Strain rate | 1/s | 4.4 | 10.9 | 18.3 | — | — | — |
| Tensile modulus | MPa | 710 | 1,500 | 2,200 | 2,340 | 2,250 | 2,120 |
| Tensile strength | MPa | 20.1 | 29.2 | 79.0 | 28.9 | 28.2 | 26.6 |
| Notched Charpy | kJ/m² | 41 | 47 | 51 | 37 | 37 | 34 |
| impact strength | | | | | | | |

1. A polyolefin composition (I) comprising:
(A) 15-80% by weight of a heterophasic polymer composition comprising:
(a) 50-80% by weight of a propylene polymer selected from the group consisting of propylene homopolymers, propylene copolymers, and mixtures thereof,
wherein the propylene copolymers are propylene copolymers with ethylene or an alpha-olefin of formula CH₂═CHR¹, wherein R¹ is a linear or branched C2-C8 alkyl, and have up to and including 10.0% by weight of units deriving from ethylene or the alpha-olefin, based on the weight of (a); and
(b) 20-50% by weight of a copolymer of ethylene and an alpha-olefin of formula CH₂═CHR¹, wherein R¹ is a linear or branched C2-C8 alkyl, having from 10 to 40% by weight of units deriving from the alpha-olefin, based on the weight of (b),
wherein the amounts of components (a) and (b) are based on the total weight of (a)+(b); and
(B) 20-85% by weight of a polyethylene composition comprising:
(i) 25-85% by weight of a polyethylene component, having a weight average molecular weight Mw(i), measured by Gel Permeation Chromatography, equal to or higher than 1,000,000 g/mol; and
(ii) 10-65% by weight of a polyethylene component, having a weight average molecular weight Mw(ii), measured by Gel Permeation Chromatography, equal to or lower than 5,000 g/mol,
wherein the polyethylene composition (B) comprises at least 70% by weight of (i)+(ii) and the amounts of (i) and (ii) are based on the total weight of the polyethylene composition (B), the total weight being 100%,
wherein the amounts of components (A) and (B) are based on the total weight of (A)+(B).

2. The polyolefin composition (I) of claim 1, comprising 40-80% by weight of the heterophasic polymer composition (A) and 20-60% by weight of the polyethylene composition (B).

3. The polyolefin composition (I) of claim 1, wherein the component (A) is an heterophasic polymer composition comprising:
(a) 35-70% by weight of a propylene polymer selected from the group consisting of propylene homopolymers, propylene copolymers with ethylene or an alpha-olefin of formula CH₂═CHR¹, wherein R¹ is a linear or branched C2-C8 alkyl, having up to and including 10.0% by weight of units deriving from ethylene and or the alpha-olefin, based on the weight of (a);
(b) 15-40% by weight a copolymer of ethylene and an alpha-olefin of formula CH₂═CHR¹, wherein R¹ is a linear or branched C2-C8 alkyl, having from 10 to 40% by weight of units deriving from the alpha-olefin, based on the weight of (b);
(c) 5-30% by weight of a copolymer of propylene with ethylene or an alpha-olefin of formula CH₂═CHR¹, wherein R¹ is a linear or branched C2-C8 alkyl, having up to and including 50% by weight of units deriving from ethylene or the alpha-olefin, based on the weight of (c);
wherein the amounts of components (a), (b), and (c) are based on the total weight of (a)+(b)+(c).

4. The polyolefin composition (I) according to claim 1, wherein the heterophasic polymer composition (A) has the alpha-olefin selected from the group consisting of butene-1, hexene-1,4-methyl-1-pentene, octene-1, and combinations thereof.

5. The polyolefin composition (I) according to claim 1, wherein the polyethylene composition (B) comprises:
(i) 25-85% by weight of a polyethylene component, having a weight average molecular weight Mw(i), measured by Gel Permeation Chromatography, equal to or greater than 1,000,000 g/mol;
(ii) 10-65% by weight of a polyethylene component, having a weight average molecular weight Mw(ii), measured by Gel Permeation Chromatography, equal to or lower than 5,000 g/mol, and
(iii) up to and including 100% by weight of a polyethylene component different from component (i) and from component (ii),
wherein the polyethylene composition (B) comprises at least 70% by weight of (i)+(ii) and the amounts of components (i) and (ii) are based on the total weight of the polyethylene composition (B), the total weight being 100%.

6. The polyolefin composition (I) according to claim 1, wherein polyethylene components (i) and (ii) being ethylene homopolymers.

7. The polyolefin composition (I) according to claim 1, wherein the polyethylene composition (B) has a Mw/Mn(B) value equal to or greater than 300 and the polyethylene components (i) and (ii) have a Mw/Mn independently selected from values of up to and including 5, wherein Mw is the weight average molecular weight and Mn is the number average molecular weight measured by GPC.

8. The polyolefin composition (I) according to claim 1, wherein the polyethylene composition (B) has a melt flow rate MFR(B), measured at 190° C. with a load of 2.16 Kg according to ISO 1133-2:2011, of up to and including 10 g/10 min.

9. The polyolefin composition (I) according to claim 1, further comprising up to and including 40% by weight of a component (C) selected from the group consisting of:
(C1) reinforcing agents;
(C2) saturated or unsaturated styrene or alpha-methylstyrene block copolymers;
(C3) polyolefins functionalized with a compound selected from the group consisting of maleic anhydride, C1-C10 linear or branched dialkyl maleates, C1-C10 linear or branched dialkyl fumarates, itaconic anhydride, C1-C10 linear or branched itaconic acid, dialkyl esters, maleic acid, fumaric acid, and itaconic acid;
(C4) an additive selected from the group consisting of pigments, dyes, extension oils, flame retardants, UV resistants, UV stabilizers, lubricants, antiblocking agents, slip agents, and waxes; and
(C5) combinations thereof,
wherein the amount of component (C) is based on the total weight of (A)+(B)+(C), the total weight being 100%.

10. A process for manufacturing a shaped article comprising a step of subjecting a flow of the molten polyolefin composition (I) according to claim 1 to a shear rate equal to or greater than 50 s⁻¹.

11. The process according to claim 10, wherein the step of subjecting a flow of the molten polyolefin composition (I) to a shear rate equal to or greater than 50 s⁻¹ is carried out by injection molding or by an extrusion-based process.

12. The process according to claim 10, wherein the step of subjecting a flow of the molten polyolefin composition (I) to a shear rate equal to or greater than 50 s⁻¹ is carried out by injection molding and the shear rate ranges from 50 to 3,000 s⁻¹.

13. The process according to claim 10, wherein the step of subjecting a flow of the molten polyolefin composition (I) to a shear rate equal to or greater than 50 s⁻¹ is carried out by extrusion-based 3D printing and the shear rate ranges from 50 to 1,000 s⁻¹.

14. A shaped article manufactured according to the process of claim 10.

15. The shaped article according to claim 14, wherein the shaped article is a filament for extrusion-based additive manufacturing.

16. (canceled)
